(19) United States
(12) Patent Application Publication
(10) Pub. No.: US 2024/0334915 A1
(43) Pub. Date: Oct. 10, 2024

(54) AQUARIUM SCRAPER

(71) Applicants: Michael SLATTERY, Rochester, NY (US); Jeremiah EYSTER, Rochester, NY (US)

(72) Inventors: Michael SLATTERY, Rochester, NY (US); Jeremiah EYSTER, Rochester, NY (US)

(21) Appl. No.: 18/624,690

(22) Filed: Apr. 2, 2024

Related U.S. Application Data
(60) Provisional application No. 63/457,677, filed on Apr. 6, 2023.

(51) Int. Cl. A01K 63/10; B08B 1/16; B08B 5/04

(52) U.S. Cl. CPC A01K 63/10; B08B 1/165; B08B 5/04

(57) ABSTRACT

An aquarium scraper, comprising a scraper head having a top opening and a bottom opening defining a distal end of the scraper head, an outlet opening defining a proximal end of the scraper head, an internal cavity disposed between the ends adapted to receive fluid therethrough, the internal cavity having a first cavity and a second cavity therein, the first cavity in communication with the top opening, the second cavity in communication with the bottom opening and the outlet opening, a handle having a first opening defining a proximal end and a second opening defining a distal end, the handle having an internal cavity disposed between the ends of the handle, the proximal end of the handle arranged to removably engage the proximal end of the scraper head, and a cartridge retractably arranged within the first cavity, the cartridge having a blade removably attached therein and extending therefrom.

### CROSS-REFERENCE TO RELATED APPLICATIONS

This application claims the benefit under 35 U.S.C. § 119 (e) to U.S. Application No. 63/457,677, filed Apr. 6, 2023, which application is incorporated by reference herein it its entirety.

### FIELD

The present disclosure generally relates to a scraper, specifically an aquarium scraper for water tanks, e.g., aquariums.

### BACKGROUND

Aquariums, typically having transparent sidewalls, need to be regularly cleaned. This is because algae, along with other debris, will build upon the sidewalls after time, making the aquarium appear dirty and distorting the view of the marine life therein.

Typically, these sidewalls are cleaned by using specialty tools, such as scrapers, sponges and the like. However, when debris is removed from the sidewalls, the debris circulate into the water, i.e., are released into the water column, populating the water, which can ultimately make a simple sidewall cleaning job much more difficult as the water may then need to be replaced entirely. The free-floating debris has the potential to attach itself to other surfaces in the aquarium.

Therefore, the typical method of dealing with the free-floating debris is to perform a large water change of the entire aquarium after all of the debris has been removed from the sidewalls and other surfaces. Not only is this a time intense activity, but the replacement water must also be treated to specific parameters before being introduced within the aquarium, i.e., temperature, pH, salinity, etc.

Aquarium scrapers, algae scrapers, or just scrapers, are known in the art. One example is detailed in U.S. Published Patent Application No. 2021/0059228, filed Jun. 23, 2020, which application is directed to an aquarium wall cleaner. The cleaner is detailed to include a blade arranged at a distal end of the cleaner and the blade may be threadably secured at the end of the cleaner to alter the distance the blade extends from the distal end. The distal end of the clean includes a cavity which the blade extends from, and the cavity is in communication with a proximal end allowing water to be pulled out the aquarium, into the distal end of the cleaner, through the cleaner, and out from the proximal end thereof. The cleaner, however, does include a mechanism or configuration that allows the blade length to be adjusted or completely retracted within the distal end thereof, without disengaging the threaded connection of the blade.

Another example of an aquarium scraper is disclosed in U.S. Published Patent Application No. 2023/0054027, having an effective filing date of Mar. 23, 2020, which application details a tool for cleaning the inside of a water tank, i.e., an aquarium. The application details a scraping blade formed at an extremity of the scraping tool, which the tool serves as a water conduit to remove polluted water from the tank. The scraping tool, however, is arranged in a fixed position at the extremity of the tool and is at all arranged within the extremity, i.e., the blade is always exposed unless completely removed from the tool.

Therefore, there is a long felt need for an adaptable aquarium scraper designed to minimize free floating debris after scraping.

### SUMMARY

In a general aspect, the present disclosure relates to an aquarium scraper which includes a retractable scraper cartridge, which cartridge includes a removable blade therein, a scraper head of the aquarium scraper is design to allow water to pass therethrough, and further, the scraper is arranged to fluidly connect with a siphon sealably connected therein.

In some embodiments, the present invention, the aquarium scraper may include a scraper head having a top opening and a bottom opening defining a distal end of the scraper head, an outlet opening defining a proximal end of the scraper head, an internal cavity disposed between the ends adapted to receive fluid therethrough, the internal cavity having a first cavity and a second cavity therein, the first cavity in communication with the top opening, the second cavity in communication with the bottom opening and the outlet opening, a handle having a first opening defining a proximal end and a second opening defining a distal end, the handle having an internal cavity disposed between the ends of the handle, the proximal end of the handle arranged to removably engage the proximal end of the scraper head, and a cartridge retractably arranged within the first cavity, the cartridge having a blade removably attached therein and extending therefrom.

In some configurations the cartridge of the aforementioned aquarium scraper is arranged to selectably translate within the first cavity between a blade-extended configuration and a blade-retracted configuration.

In other arrangements, the outlet opening of the aforementioned scraper head is arranged within a nozzle.

In an exemplary embodiment, the aforementioned nozzle is arranged to be inserted within a fluid conduit arranged within the handle, thereby sandwiching an end of the fluid conduit between an outer surface of the nozzle and an inner surface of the internal cavity of the handle when the handle is engaged to the nozzle, thereby fluidly connecting the second cavity and the fluid conduit.

In another aspect, the present invention may comprise an aquarium scraper having a scraper head with a top opening and a bottom opening defining a distal end, an outlet opening defining a proximal end, an internal cavity disposed between the ends, the internal cavity having a first cavity and a second cavity therein, the first cavity in communication with the top opening, the second cavity in communication with the bottom opening and the outlet opening, a nozzle arranged at the proximal end and having the outlet opening therein, a button aperture in communication with the first cavity, the button aperture having a first detent and a second detent arranged therein, a handle having a first opening defining a proximal end and a second opening defining a distal end, the handle having an internal cavity disposed between the ends of the handle, the proximal end of the handle arranged to removably engage the nozzle the scraper head, and, a cartridge retractably arranged within the first cavity, the cartridge having a blade removably attached therein and extending therefrom, the cartridge including a button hingedly attached thereto and protruding therefrom, where the button is operatively arranged to springingly engage at least one of the first detent and the second detent, thereby extending said blade past the top opening or retracting the blade within the first cavity, where the handle is operatively arranged to removable accept a fluid conduit within its internal cavity and the nozzle is operatively arranged to be inserted into an end of the fluid conduit when the proximal end of the handle and the nozzle are connected, thereby fluidly connecting the second cavity and the fluid conduit.

Thus, a general object of the present invention is to provide a safer tool for removing algae or other debris from surfaces in an aquarium, which tool includes a debris removing means, e.g., a blade, scraper element, etc., which debris removing means are retractable within the tool to prevent accidents from exposed debris removing means, such as a cutting edge of a blade.

An additional object of the present invention is to provide a cleaning tool, particularly a cleaning tool for aquariums, more specifically a tool for removing algae or other debris from surfaces in an aquarium, which tool includes a debris removing means, e.g., a blade, scraper element, etc., but is also configured to provide a siphon, vacuum, or other suction means, which collects the debris removed from the surfaces of the aquarium, thus preventing such debris from becoming free-floating within the water of aquarium.

Therefore, it can be said that the present invention is intended to provide a combination aquarium cleaning tool, e.g., include means for removing debris from aquarium surfaces and removing debris from the water once removed from the aquarium surfaces, along with a configuration for retracting a debris removing means to safely stow the debris removing means.

These and other objects, features, and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings, in which corresponding reference symbols indicate corresponding parts, in which:

FIG. 1 generally illustrates a perspective view of an aquarium scraper of the present invention;

FIG. 2 generally shows a side view of the invention shown in FIG. 1;

FIG. 3 generally shows a top view of the invention shown in FIG. 1;

FIG. 4 generally shows a front view of the invention shown in FIG. 1;

FIG. 5 generally shows a cross-sectional view taken generally along line 5-5 in FIG. 4;

FIG. 6 generally shows an exploded view of the invention shown in FIG. 1;

FIGS. 7A and 7B show perspective views of a scraper head of the invention shown in FIG. 1; and,

FIG. 8 is a cross-sectional view of the invention shown in FIG. 1 in use and with a fluid conduit arranged therein.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and, as such, may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of: ” is used herein.

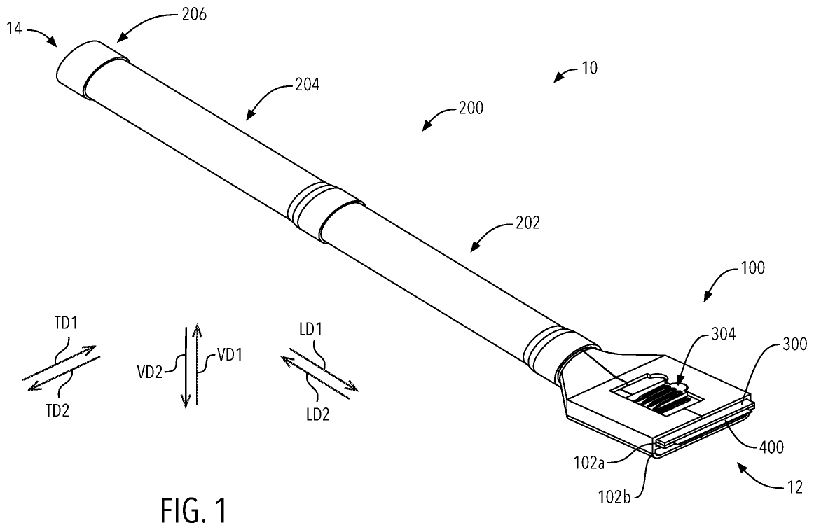

In reference to FIGS. 1 through 3, which generally illustrate a perspective, side, and top view of an example aquarium scraper device, aquarium scraper 10, respectively. Generally, scraper 10 has distal end 12 and proximal end 14, where scraper head 100 is generally disposed at distal end 12. Scraper head 100 is preferably configured to removably accept cartridge 300 therein, where cartridge 300 includes blade 400 removably secured therein and extending therefrom. Handle 200 is arranged to removably secure to scraper head 100 and extends therefrom in longitudinal direction LD1 towards proximal end 14. In some embodiment, handle 200 may be comprised of sections or portions which interconnect, e.g., first handle section 202 and second handle section 204, giving handle 200 a varying degree of length depending on the number of sections interconnected. In one possible configuration, end cap 206 may removably secure to second handle section 204. End cap 206 may be configured to have an open end and a closed end, or a pair of oppositely disposed open ends.

As generally illustrated in FIG. 1, scraper head 100 may include a pair of openings disposed proximate distal end 12, e.g., top opening 102a and bottom opening 102b, which openings are disposed within an internal cavity within scraper head 100. It should be noted that a fluid passageway or conduit is disposed between distal end 12 and proximal end 14 of aquarium scraper 10, thus proximal end 14 includes an opening to that fluid passageway or conduit and at least one of openings 102a and 102b is the opening to that fluid passageway or conduit of distal end 12. In other words, distal end 12 and proximal end 14 are fluidly connected therebetween.

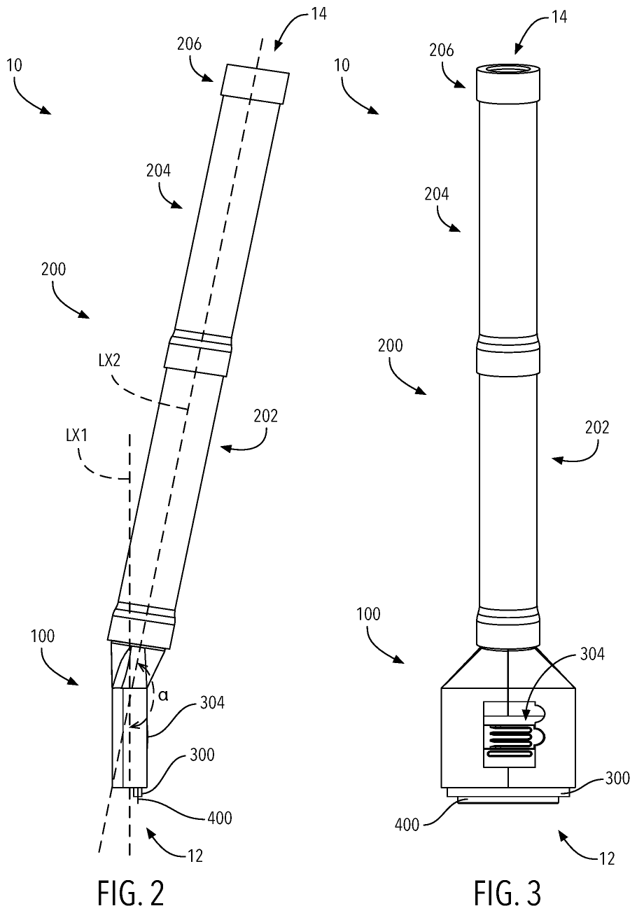

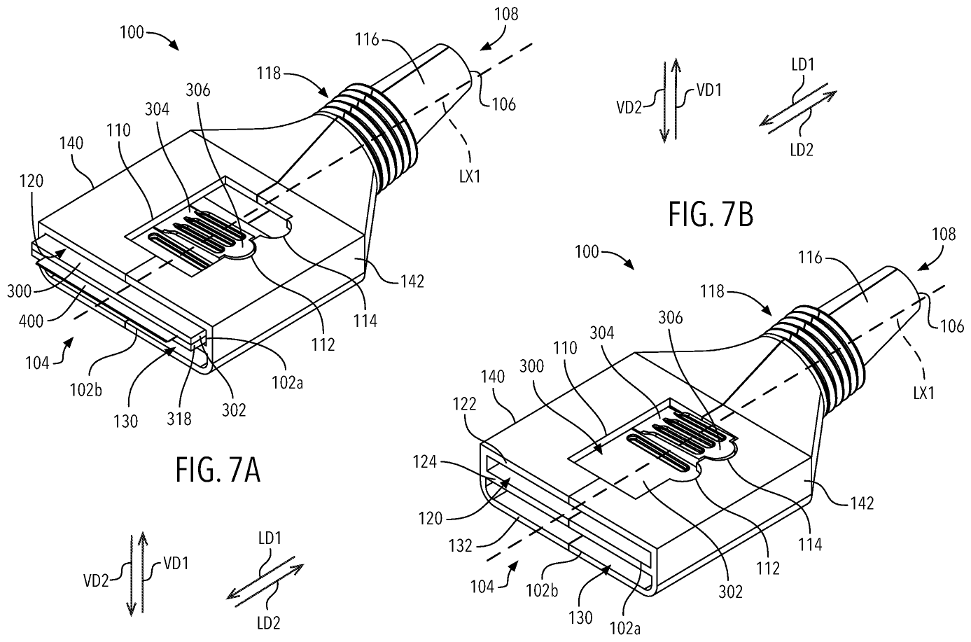

In some configurations and shown in FIG. 2, scraper head 100 is angled, e.g., handle 200 is not parallel to a cavity which holds cartridge 300 therein. The portion of scraper head 100, arranged proximate distal end 12 and where cartridge 300 is arranged within, is generally arranged about and parallel to longitudinal axis LX1. The end of scraper head 100, e.g., a nozzle (See FIGS. 7A and 7B, described infra), arranged proximate handle 200 is arranged about longitudinal axis LX2. Whereas axis LX1 and LX2 intersect and form angle α which may be greater than 90° and less than 180°, preferably closer to 180° than 90°, e.g., approximately 135° to 165°. It should be noted, however, that various possible angles are contemplated within the scope of the appended claims. The angled configuration of scraper head 100, particularly an obtuse angle between blade 400 and handle 200 provides for an optimum use-angle, making proper wall-scraping of an aquarium tank easier when axis LX2 is arranged substantially parallel, or close to, a respective wall of the aquarium tank during use.

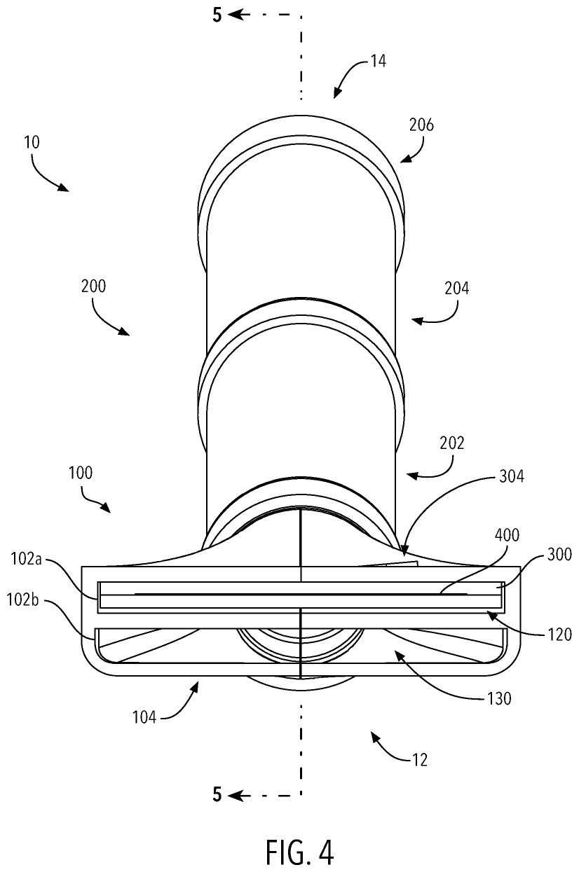

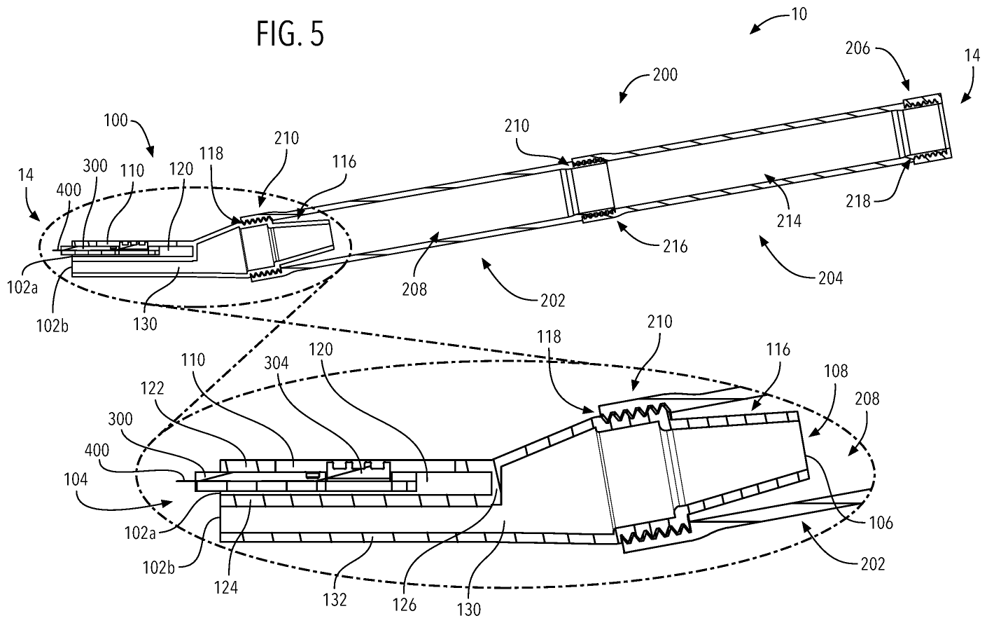

FIG. 4 shows a front view of the aquarium scraper 10, specifically the internal cavity of scraper head 100, specifically, first cavity 120 and second cavity 130, which collectively form the internal cavity. Preferably, first cavity 120 and second cavity 130 are entirely separate, i.e., not in communication therebetween, whereas top opening 102a is an opening to first cavity 120 and bottom opening 102b is one of two openings to second cavity 130. First cavity 120 is arranged to removably and retractably accept cartridge 300 therein. Button 304 of cartridge 300 releasably holds cartridge 300 at least partially, or completely, within first cavity 120—detailed further in view of FIGS. 5 through 7B, infra.

The following description should be taken in view of the aforementioned figures, particularly FIG. 5 which illustrates a cross-sectional view of aquarium scraper 10 taken generally along line 5-5 shown in FIG. 4. Preferably, first cavity 120 and second cavity 130 are bifurcated, i.e., separated or not in communication therebetween. As such, in a preferably embodiment, second cavity 130 is in fluid communication, from bottom opening 102b to outlet opening 106, with internal cavity 208 of first handle portion 202 (and therefore internal cavity 14 of second handle portion 204) of handle 200. In other words, second cavity 130 is in fluid communication with handle 200. Cavity 120 has opening 102a and is closed off at a respective opposite end, e.g., end wall 126, as generally shown in FIG. 5. In the example configuration shown in FIG. 5, cavity 120 is generally defined by top wall 122, medial wall 124, end wall 126, and respective sidewalls 140 and 142 (See FIGS. 7A and 7B), and has opening 102a and aperture 110 (disposed within top wall 122) in communication therewith. First cavity 120 is arranged to removably, retractably, and/or slidably accept cartridge 300 therein. As shown, button 304 of cartridge 300 is arranged to be springingly engaged within aperture 110 of scraper head 100, i.e., a button aperture of the scraper head, thus, button 304 and therefore cartridge 300, may translate within aperture 110 (or be completed removed from cavity 120 and scraper head 100), as discussed further in view of FIGS. 7A and 7B. In the example configuration shown in FIG. 5, cavity 130 is generally defined by a portion of top wall 122 proximate end 108, medial wall 124, end wall 126, bottom wall 132, and respective sidewalls 140 and 142 (See FIGS. 7A and 7B), and has openings 102b and 106.

In a preferred configuration, scraper head 100 includes distal end 104—generally defined by openings 102a and 102b and the end of scraper head 100 where blade 400 may extend therefrom, and proximal end 108—generally defined by outlet opening 106. As shown, opening 106 is arranged within nozzle 116, where nozzle 116 also includes cavity 130 therein. Nozzle 116 may be substantially frustoconical in exemplary configurations, however, variations are contemplated within the scope of the appended claims. In some embodiments, nozzle 116 may include one or more of a connection element or connection elements 118 arranged on an outer surface thereof. Connection elements 118 may be threading, or other removable connection elements, such as but not limited to snap-fit, frictional fit, quick-release, or the like. Connection elements 118 of nozzle 116 are arranged to removably, and preferably, sealably engage female end 210 of first handle portion 202. As such, female end 210 (and male end 212, along with ends 216 and 218 of second handle portion 204), will have corresponding connection elements, i.e., threading, or other removable connection elements, such as but not limited to snap-fit, frictional fit, quick-release, or the like. It should be noted that “male” and “female”, as described above, are intended to mean that the female element accepts the male element at least partially therein, however, such interaction is not required to removably connect two elements and therefore should not be considered restrictive on the scope of the appended claims.

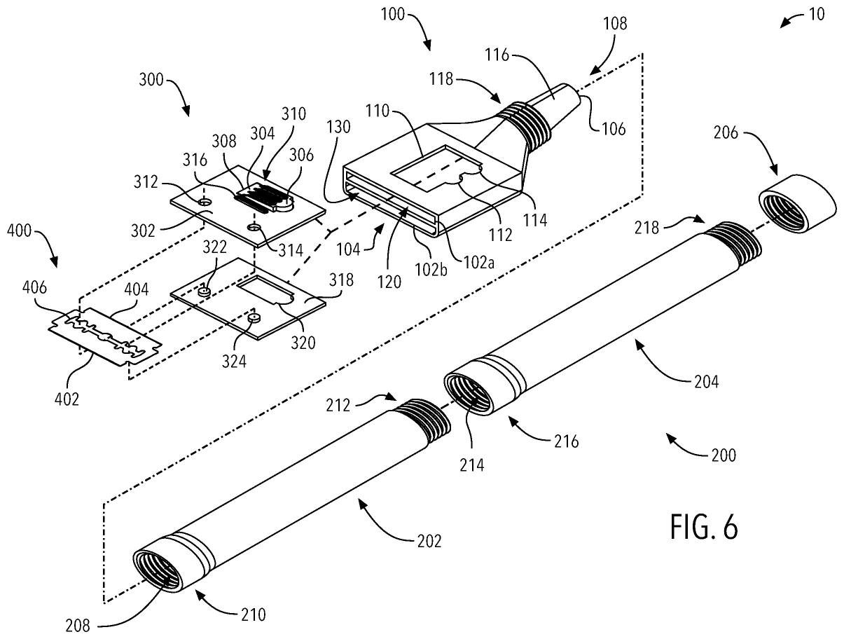

FIG. 6 shows an exploded embodiment of the present invention, aquarium scraper 10. Beginning with blade 400 and cartridge 300, blade 400 may be configured as a double-edged razor blade, i.e., having a pair of oppositely disposed cutting edges, e.g., edges 402 and 404, which blade include aperture 406 disposed therein and between edges 402 and 404. Cartridge 300 may have first plate 302 and second plate 318 which are arranged to removably attached and sandwich blade 400 therein.

In some arrangements, first plate 302 includes button 304 springingly attached thereto via hinge 308, which hinge is preferably a living hinge and is operatively arranged to bias button to protrude upwardly (i.e., in a direction away from second plate 318 arranged thereunder). Button 304 may be configured to have protruding elements 310 extending therefrom, which may take the form of raised ridges, bumps, etc., thereby providing a tactile and/or gripping surface thereon. First plate 302 may further include pin apertures 312 and 314, and slot 316 arranged substantially between pin apertures 312 and 314 and button 304. Slot 316 is preferably arranged to protrude in a direction towards second plate 316, i.e., forming a protrusion extending from a bottom surface thereof.

In some embodiments, second plate 318 includes aperture 320 therein, which aperture is arranged to be substantially colinear with an outer edge of button 304 of first plate 302 such that when button 304 is depressed it may rest at least partially within aperture 320, until the force of the depression is released. Second plate 318 may also includes pins 322 and 324 which are arranged to be substantially colinear with pin apertures 312 and 314, and are operatively arranged to removably engage the respective pin apertures, thereby securing second plate 318 to first plate 302. Further, pins 312 and 314 pass through aperture 406 of blade 400, thereby locking blade 400 between first plate 302 and second plate 318 when the pins are engaged within their respective apertures. It should be noted that various other methods of removably securing blade 400 to cartridge 300, and such alternatives, known in the art of replaceable razor blades, are intended to fall within the scope of the appended claims.

In reference to the aforementioned figures and specifically FIGS. 7A and 7B, which show scraper head 100 isolated from handle 200 in a blade-extended configuration and a blade-retracted configuration, respectively. Detents 112 and 114 of aperture 110 correspond to the blade-extended configuration (See FIG. 7A) and the blade-retracted configuration (See FIG. 7B), respectively. In other words, depending on which of detents 112 or 114 protrusion 306 of button 304 is engaged therewith, blade 400 is locked into one of the respective configurations. To translate cartridge 300 within cavity 120 and along longitudinal axis LX1, button 304 is depressed, thereby moving (in vertical direction VD2) protrusion 306 into internal cavity 120 and out of either detent 112 or 114, allowing cartridge 300 to translate substantially along longitudinal axis LX1 in longitudinal directions LD1 and LD2. If button 304 is depressed, cartridge 300 may be continually translated in longitudinal direction LD1 until it is removed from opening 102a cavity 120. Likewise, if button 304 is depressed, cartridge 300 may be inserted into opening 102a of cavity 120 where proximal wall 122 will keep button 304 depressed until protrusion 308 reaches one of detents 112 or 114, where hinge 308 will bias button 304 to move in vertical direction VD1 such that protrusion rests within one of the respective detents.

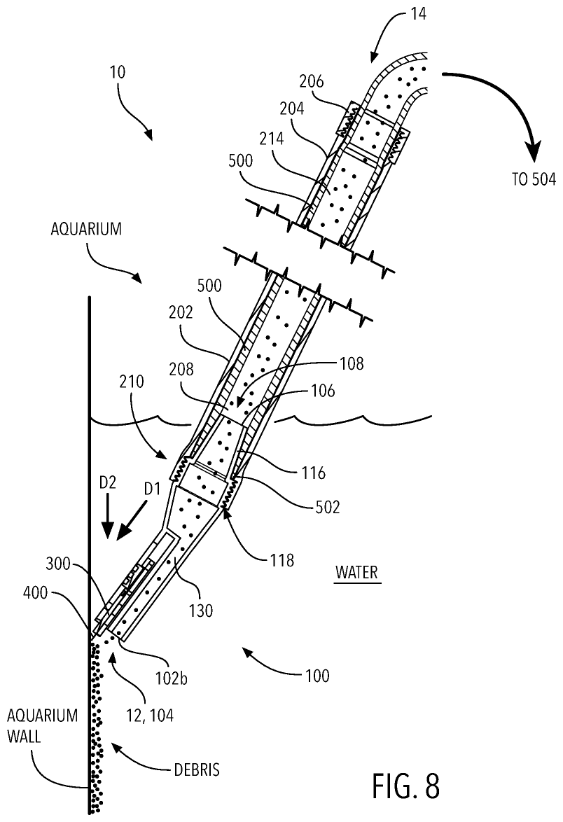

In FIG. 8, aquarium scraper 10 is generally shown in cross-section with a fluid conduit arranged therein and the scraper in use. As shown, the fluid conduit, e.g., siphon tube 500 is in fluid communication with second cavity 130, i.e., fluid may flow from opening 102b into second cavity 130 and out of opening 106 into siphon tube 500 to then exit from end 504 of siphon tube 500. Siphon tube 500 may be arranged in a manner that uses gravity to move liquid from one container, e.g., an aquarium, to another, e.g., an external container, when the container with the liquid, e.g., the aquarium, is higher than the external container. In other words, end 504 of siphon tube 500 is lower than the lowest point of a liquid within the aquarium.

Once siphon tube is inserted and arranged within the handle, e.g., within internal cavities 208 and 214 of first handle portion 202 and second handle portion 204, respectively—or at least one of the handle portions, an outer surface of nozzle 116 and an inner surface of internal cavity 208 of first handle portion 202 of the handle, pinch, or frictionally secure, end 502 therebetween, when end 210 is engaged within connecting element 118, thereby fluidly connecting cavity 130 and siphon tube 500, i.e., creating a closed fluid circuit from opening 102b of cavity 130 to end 504 of siphon tube 500. In other arrangements, end 502 of siphon tube 500 may be removably secured proximate end 14 of aquarium scraper 10, e.g., substantially within the handle proximate end cap 206, thus fluidly connecting cavity 130, internal cavity 208, and internal cavity 214, i.e., creating a closed fluid circuit from end 12 to proximate end 14 of aquarium scraper.

As generally illustrated, an aquarium wall has a plurality of debris, e.g., algae, attached therein and within the water. To remove the debris, blade 400 is moved in direction D1 until it contacts the aquarium wall at an angle, then blade 400 is moved along aquarium wall in direction D2 while force is still applied to blade 400 in direction D1. Once blade 400 removes the debris, the aforementioned siphoning, suctioning, vacuuming, pulls the debris into opening 102b which travels from distal end 12 to exit proximal end 14, within siphon tube 500 to exit from end 504 of siphon tube 500. The debris and water that exits end 504 of siphon tube 500 is collected in an external container and discarded.

It will be appreciated that various aspects of the invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Aquarium scraper
12 Distal end
14 Proximal end
100 Scraper head
102a Top opening
102b Bottom opening
104 Distal end
106 Outlet opening
108 Proximal end
110 Aperture
112 Detent
114 Detent
116 Nozzle
118 Connection element
120 First cavity
122 Top wall
124 Medial wall
126 End wall
130 Second cavity
132 Bottom wall
140 Sidewall
142 Sidewall
200 Handle
202 First handle portion
204 Second handle portion
206 End cap
208 Internal cavity
210 Female end
212 Male end
214 Internal cavity
216 Female end
218 Male end
300 Cartridge
302 First plate
304 Button
306 Protrusion
308 Hinge
310 Protruding elements
312 Pin aperture
314 Pin aperture
316 Slot
318 Second plate
320 Aperture
322 Pin
324 Pin
400 Blade
402 Edge
404 Edge
406 Aperture
500 Siphon tube
502 End
504 End
D1-D2 Direction
LD1-LD2 Longitudinal direction
LX1-LX2 Longitudinal axis
TD1-TD2 Transverse direction
VD1-VD2 Vertical direction
α Angle

What is claimed is:

1. An aquarium scraper, comprising:
a scraper head having a top opening and a bottom second opening defining a distal end of said scraper head, an outlet opening defining a proximal end of said scraper head, an internal cavity disposed between said ends adapted to receive fluid therethrough, said internal cavity having a first cavity and a second cavity therein, said first cavity in communication with said top opening, said second cavity in communication with said bottom inlet opening and said outlet opening;
a handle having a first opening defining a proximal end and a second opening defining a distal end, said handle having an internal cavity disposed between said ends of said handle, said proximal end of said handle arranged to removably engage said proximal end of said scraper head; and,
a cartridge retractably arranged within said first cavity, said cartridge having a blade removably attached therein and extending therefrom.

2. The aquarium scraper recited in claim 1, wherein said cartridge is arranged to selectably translate within said first cavity between a blade-extended configuration and a blade-retracted configuration.

3. The aquarium scraper recited in claim 1, wherein said outlet opening is arranged within a nozzle.

4. The aquarium scraper recited in claim 3, wherein said nozzle is arranged to be inserted within a fluid conduit arranged within said handle, thereby sandwiching an end of said fluid conduit between an outer surface of said nozzle and an inner surface of said internal cavity of said handle when said handle is engaged to said nozzle, thereby fluidly connecting said second cavity and said fluid conduit.

5. The aquarium scraper recited in claim 1, wherein said first cavity includes a button aperture, said button aperture having a first detent and a second detent arranged therein.

6. The aquarium scraper recited in claim 5, wherein said cartridge includes a button springingly attached thereto, said button operatively arranged to releasably engage at least one of said first detent and said second detent of said button aperture when said cartridge is within said first cavity.

7. The aquarium scraper recited in claim 6, wherein said blade extends from said first cavity when said button is engaged within said first detent and said blade is substantially within said first cavity when said button is engaged within said second detent.

8. The aquarium scraper recited in claim 1, wherein said handle includes at least two sections, said at least two sections arranged to removably connect to each other.

9. The aquarium scraper recited in claim 1, wherein said top opening and said bottom opening are arranged substantially parallel to a first longitudinal axis and said outlet opening is arranged about a second longitudinal axis, wherein said first longitudinal axis and said second longitudinal axis intersect and form an angle greater than 90° therebetween.

10. The aquarium scraper recited in claim 1, wherein said cartridge includes a first plate and a second plate, said button arranged springingly engaged within said first plate, said first plate comprising at least one pin aperture, said second plate including an aperture therein and at least one pin extending therefrom, whereas said at least one pin is operatively arranged to rest within at least one blade aperture on said blade and engages said at least one pin aperture thereby securing said first plate to said second plate and sandwiching said blade therebetween.

11. An aquarium scraper, comprising:
a scraper head having a top opening and a bottom opening defining a distal end, an outlet opening defining a proximal end, an internal cavity disposed between said ends, said internal cavity having a first cavity and a second cavity therein, said first cavity in communication with said top opening, said second cavity in communication with said bottom opening and said outlet opening, a nozzle arranged at said proximal end and having said outlet opening therein, a button aperture in communication with said first cavity, said button aperture having a first detent and a second detent arranged therein;
a handle having a first opening defining a proximal end and a second opening defining a distal end, said handle having an internal cavity disposed between said ends of said handle, said proximal end of said handle arranged to removably engage said nozzle of said scraper head; and,
a cartridge retractably arranged within said first cavity, said cartridge having a blade removably attached therein and extending therefrom, said cartridge including a button hingedly attached thereto and protruding therefrom, said button operatively arranged to springingly engage at least one of said first detent and said second detent, thereby extending said blade past said top opening or retracting said blade within said first cavity,
wherein said handle is operatively arranged to removable accept a fluid conduit within its internal cavity and said nozzle is operatively arranged to be inserted into an end of said fluid conduit when said proximal end of said handle and said nozzle are connected, thereby fluidly connecting said second cavity and said fluid conduit.

12. The aquarium scraper recited in claim 11, wherein said handle includes at least two sections, said at least two sections arranged to removably connect to each other.

13. The aquarium scraper recited in claim 11, wherein said top opening and bottom second opening are arranged substantially parallel to a first longitudinal axis and said outlet opening is arranged about a second longitudinal axis, wherein said first longitudinal axis and said second longitudinal axis intersect and form an angle greater than 90° therebetween.

14. The aquarium scraper recited in claim 11, wherein said cartridge includes a first plate and a second plate, said button springingly engaged within said first plate, said first plate comprising at least one pin aperture, said second plate including an aperture therein and at least one pin extending therefrom, wherein said at least one pin is operatively arranged to rest within at least one blade aperture on said blade and engages said at least one pin aperture thereby securing said first plate to said second plate and sandwiching said blade therebetween.

15. The aquarium scraper recited in claim 11, wherein said fluid conduit comprises a siphon tube.
